(19) United States
(12) Patent Application Publication
(10) Pub. No.: US 2023/0343313 A1
(43) Pub. Date: Oct. 26, 2023

(54) METHOD OF PERFORMING A PIECE OF MUSIC

(71) Applicant: Wejam Limited, London (GB)

(72) Inventor: David Tshulak, London (GB)

(21) Appl. No.: 18/016,385

(22) PCT Filed: Jul. 14, 2021
(86) PCT No.: PCT/GB2021/051808

§ 371 Date: Jan. 16, 2023

(30) Foreign Application Priority Data
Jul. 17, 2020 (GB) 2011057.3

(51) Int. Cl. G10H 1/00

(52) U.S. Cl. CPC G10H 1/0025; G10H 2210/051; G10H 2210/101; G10H 2210/161

(57) ABSTRACT

A method for performing a piece of music comprising the steps of: receiving (310) an input signal from a musical instrument (220), the inputs signal encoding the notes played on the instrument (220), matching (320) a note or combination of notes in the input signal to a respective trigger in a predefined set of triggers stored in a memory (130), each trigger being associated with a respective fragment of music that makes up a part of the piece of music, each fragment having a predefined length and starting from a predefined position relative to the start of a bar, and at least one of the fragments being more complex than the associated trigger, wherein when a note or combination of notes that matches a trigger is played by the user the method outputs (330) at least part of the matched fragment that starts at the time that the note or combination of notes is played.

This invention relates to a method and a system for enabling one or a group of people to learn or practice or otherwise experience playing an instrument.

Many people want to learn to play a musical instrument, or to learn to read music in order to play an instrument. One of the most enjoyable parts of the learning process is being able to play a piece of music with that instrument, and better still to be able to play along with other musicians or to a backing track of a favourite piece of music.

For many students learning to play, the experience of not being able to play complex pieces until quite accomplished can be quite demotivating. It means they can only perform simple, unappealing music, and cannot join in a group with other more accomplished players. For a younger generation familiar with the instant gratification experienced in other areas, particularly computer gaming, this can cause them to give up on learning before they have really got very far.

### SUMMARY OF THE INVENTION

In accordance with various embodiments of the present invention, systems and methods provided for enabling users to perform a piece of music along with other users or against a backing track regardless of different levels of ability of the users by augmenting the notes that they play.

The term performing as used here covers both playing a piece of music so that it is audible, as a live performance, or playing a piece of music that is recorded as a live recording. The live recording may later be replayed audibly as a pre-recorded performance.

A first aspect of the present invention, for example, is directed to a method for performing a piece of music comprising the steps of:
receiving an input signal from a musical instrument, the input signal encoding the notes played on the instrument,
matching a note or combination of notes in the input signal to a respective trigger in a predefined set of triggers stored in a memory, each trigger being associated with a respective fragment of music that makes up a part of the piece of music, each fragment having a predefined length and starting from a predefined position relative to the start of a bar, and at least one of the fragments being more complex than the associated trigger,
characterised in when a note or combination of notes that matches a trigger is played by the user the method outputs the part of the matched fragment that starts at the time that the note or combination of notes is played.

A note or combination of notes played by a user and encoded in the input signal may be a match to a trigger that has the same note or combination of notes. For example if the user plays a middle C note, this will match to a trigger that comprises only a middle C, a D chord will match a trigger that comprises a D chord and so on.

A trigger can be a single note or combination of notes played simultaneously (a chord) or substantially simultaneously, by which we may mean within a maximum time period of 20 milliseconds from the start of the first note.

The method may attempt to make a match each time a note or combination of notes occurs in the input signal, in real time as the user is playing the notes. There may of course be a slight delay as the input signal is generated and processed and so on, but to the user it is preferable that this is kept as small as possible.

The method may include setting user defined, or preset threshold time, set in milliseconds or fractions of a beat, for determining if the user has played a combination of notes ‘simultaneously’ and to take each note as part of the trigger. The trade-off is that a longer threshold is beneficial for beginners to find the right notes at the same time, but the threshold also by its nature introduces a delay between the first note being hit and then being heard, as the system waits to see if any other notes are to follow.

The method of the invention therefore comprises enabling a user to perform a part of a piece of music by producing a simple sequence of notes that each match to a correct series of triggers played one after the other, the triggers causing a sequence of more complex notes defined by the associated fragments to be output. This enables a player of low ability to play a complex part of a piece of music, such as a guitar part or keyboard part.

The method is suitable for use with any type of instrument. An instrument can be digital or acoustic, and as well as the conventional musical instruments such as keyboard or guitar can include music making devices such as sampling machines or even voice. Where the instrument is acoustic a means for converting the audio generated by the instrument to a digital signal will be needed but these are widely available.

In the method of the invention a fragment is only output when it is triggered and may not start at the beginning of the fragment so the whole fragment may not be output if the trigger occurs part way through a fragment.

The method may comprise synchronising the start of the fragments to set points in the part of the piece of music, for example to the start of each bar or to start on each note within a bar, and will be output in its entirety only if the user plays the correct notes exactly at the start time of the fragment.

The step of outputting a fragment from the point where it is triggered may comprise passing the fragment to an audio playback device. Prior to outputting the fragment it will not be audible but after passing to the output it will be audible.

The fragments may all have the same length or each may have a length that is specific to that fragment.

Each of the fragments may correspond to a portion of the piece of music being played that has a duration equal to one bar.

A fragment in some implementations of the method may have a length that is less than a bar - e.g. one beat or even a fraction of a beat. A fragment may have a length greater than one bar. This may be applicable where the playing of a trigger corresponds to a sustained note that lasts for more than one bar, but also for the trigger of a complex fragment that lasts for more than one bar.

One fragment could correspond to a combination of notes (a chord) and nothing else.

The method may employ a set of fragments that may each have the same duration, which may correspond to one bar and each start at the same point in the bar. The fragment may comprise a number of notes of different or equal duration and the time within the fragment that the notes are to be reproduced, e.g. on the first beat, or second beat, and so on.

A fragment may commence with the first beat of a bar, or at some other defined point within the bar.

A fragment may be associated with only one bar or selected bars in the piece of music so that it will only be output if the correct trigger is played at that time or within the duration of the fragment, in the latter case only part of the fragment being output.

In a preferred arrangement, all fragments start on the first beat but some may include an initial period of padding with no notes if the notes are not to output until later in the bar. The user will play the trigger at the correct time in the piece of music which may then be later than the start of the fragment, and even though the fragment is output part way through at that point this will generate the desired notes at the right time as only the initial silent part is not output.

To play a piece of music the user performs a series of triggers at the correct point in time so as to cause the correct fragment to start to be output.

If a fragment is synchronised to each bar it can be played at any time in the piece of music, but if only synchronised to selected bars it can only be played at selected times. For instance, a fragment associated with a chorus may only be available to play at the time of the chorus and not at other times.

A fragment in some implementations of the method may be less than a bar - e.g. a fraction of a beat. These shorter fragments, if started at the beginning of a bar, will end before the bar ends. Alternatively, padding may be added at the end to fill the bar.

One single trigger could correspond to a combination of notes (a chord) and nothing else. The fragments may each have the same duration, which may correspond to one bar. The fragment may comprise a number of notes of different or equal duration and the time within the fragment that the notes are to be reproduced, e.g. on the first beat, or second beat, and so on.

Where the term bar is used, we mean a fragment in time within a piece of music that corresponds to a fixed number of beats, the piece of music being made up from multiple bars played one after another. This is conventional within musical notation. A piece of music could of course be divided up in different ways within the scope of the present invention.

The method may play each fragment on a loop synchronised to the first beat of each bar or with each beat of the selected bars or beats.

Where each fragment is played on mute this may correspond to the fragment not being output, and when taken off mute it may correspond to being output within the terms used to define this invention. Where a fragment plays on repeat on mute the step of outputting a part of a fragment associated with a matched trigger may comprise turning off the mute from that point in time within the fragment when the note or chord of notes associated with the trigger is played so the rest of the fragment can be heard until the end of the fragment whereupon it continues to play on mute.

The method may output one instance of a fragment each time a trigger match is made, or may output a continuous loop of fragments if the note in the input signal is held. The term held as it depends on the instrument.

For example, on a keyboard held could mean the user keeping a key or combination of keys depressed for longer than the duration allocated to each trigger, on a guitar held could mean the note is live or sustained.

The method may comprise processing triggers and the fragments of music that are each encoded in the form of midi files and stored in an electronic memory.

The method may comprise providing a set of fragments that define all the subparts needed for a user to play the whole of a part of the piece of music. This will allow the user, by playing the appropriate sequence of notes or combination of notes, to play an entire part of a piece of music on their own.

Many pieces of music have more than one part, with each corresponding to a different instrument. A classic rock song, for example, may have a part for a drummer, a different part for a lead guitarist, and a different part for a bass guitarist. To play the whole rock song three players will play three different instruments with each playing one track.

Where multiple players are each playing a respective instrument, the method may receive and match multiple input signals. Depending on the protocol used these may all be encoded onto one master input signal but they could all be processed individually.

Most beneficially, the method may provide multiple sets of fragments, each set corresponding to one part of the piece of music. A set of fragments may audibly output as a guitar part, and another set as a drum part for example.

The method may also process more than one trigger sequence associated with each set of fragments. There may be triggers for a set of drum fragments and different triggers for a set of guitar fragments.

The method may permit the user to define the specific instrument from a type of instruments to be selected and thereby choose which set of fragments they will trigger. For instance, they may select that the played part sounds like a 12 string guitar, or an acoustic guitar or an electric guitar.

In a refinement, the method may comprise providing two or more sets of trigger signals, each associated with a different level of difficulty, and the method may assign a difficulty level to each user, thereafter only matching the input note or combinations of notes to the chosen set of triggers.

For example, there may be three levels- easy/beginner, medium/intermediate and hard/expert. The triggers for the beginner level may each comprise a single note. To achieve a match an inexperienced user only needs to play the right single note at the right time and a fragment will be audibly played.

For an advanced user the trigger may be a combination of two or more notes to be played simultaneously, so the user must play that more complex combination to make a match to a trigger and audibly output the same fragment that the beginner would trigger. This allows players of different skill levels to play together.

The method may comprise providing additional feedback to a user to indicate their performance compared to an ideal performance. This may take account of the timing of the note being played, but also how hard the note is played and how long the note is sustained. The feedback may be determined by comparing the timing of the notes that produced a match to a trigger with an ideal timing.

The method may comprise providing cues to the user to aid them in playing the correct note or correct sequence of notes at the correct time.

The cues may be presented in the form of a webpage (or app, or video projection) allowing them to be viewed on any suitable computer device, such as a desktop computer, laptop computer, tablet or smartphone. The cues may be presented alternatively or additionally on a part of an instrument that the user may play, or on a device that may be fixed to the instrument.

At least one cue may indicate to the players when the piece of music starts.

The method may comprise receiving from a user a selection of a piece of music, and selecting the appropriate set of triggers and fragments that enable that piece of music to be played. The piece of music can be anything from a jazz piece, to a classical music piece, to a pop song or rock song. This is in no way an exhaustive list of genres of music that the invention can be applied to.

The method may be used to enable a piece of music to be performed using any musical instrument that is able to generate an electronic signal or an audible sound that can be converted into a suitable electronic signal. The term musical instrument is to be interpreted broadly to cover conventional instruments such as guitars and drums and keyboards but also cover virtual or simulated instruments. Examples of the latter include computer programs that can be run on a computer or tablet or smartphone and enable a user to play notes on a simulated instrument. For example, a set of keys may be displayed on a touch sensitive screen that when touched by a user generates a musical note. Another example may enable a user to press a key on a conventional computer keyboard to generate an associated note.

The method may be performed in a music studio which may be equipped with everything a user will need to be able to turn up and carry out the inventive method.

The method may output an audio signal encoding the triggered fragments. Where the stored fragments are not audio files, for example where they are stored as midi data, they may be converted to audio signals prior to output so the audio signal can be played by one or more speakers or headphones, or may be recorded for later playback. The audio signal may be a digital or analogue signal.

In the arrangement of the method where the fragments are played on mute prior to output, this step of playing may comprise converting a fragment stored as a midi file to an audio signal which is played on mute.

The method may encode the fragments and the triggers as midi format data files, a format which is well known in the art. Inputs received from the instruments may also be encoded as midi format data. Alternatively, the fragments may comprise audio data. Using midi files gives increased flexibility in terms of the actual audio that can be reproduced from the data in the midi files.

According to a second aspect the invention provides a system for assisting a user in playing along to a piece of music, the system comprising:
A processing circuit having access to information stored in at least one storage device, an input device for receiving from a user an electronic signal encoding a note or combination of notes played by the user, a set of stored trigger signals, a set of stored fragments of music, each fragment having a predefined length and starting from a predefined position relative to the start of a bar, and
an output device,
in which the processing circuit is configured to match the input signal to a respective trigger, each trigger being associated with one of the stored fragments,
and in which the processing circuit is further configured to cause the output device to play audibly or record the matched fragment from the point in the piece of music corresponding to the time within the bar that the note or combination of notes of the input signal is played.

The processing circuit may play each of the fragments synchronised to a predefined time in the piece of music, for example starting on each beat or on the first beat of each bar, or on only selected bars in the piece of music. The processing circuit may therefore cycle each fragment continuously in a loop but not output the fragment until triggered.

When output by the processing circuit to the output device, the fragment will be audibly reproduced or may be recorded or both.

The output device may comprise at least one audio device selected from a group comprising but not limited to loudspeakers, headphones and audio recorders. There may be one audio device for each player, or they may all share the same audio device.

The processing circuit may be local to the players, for instance in a recording studio where all of the players are playing the piece of music.

Alternatively at least part of the control circuitry may be remote from the players. This may comprise the players being in one room and the control circuit in a different room, or a different building.

The system may include a user interface that enables a user to control the system. This may enable the user to select the song that is to be played, to select a difficulty level for each player, and to assign an instrument to each player. The system may also enable the speed of the piece of music (in bpm), and the relative volumes of each instrument to be adjusted.

The processing circuit may comprise a laptop computer or a desktop computer. This may include the storage device as an area of electronic memory, or may have access to a remote storage device either through a wired or a wireless connection.

The reader will understand that the system may enable any of the features of the method of the first aspect to be implemented.

The processing circuit may include a user input for enabling the user to input a complete track for one player and a chopper that will chop the track into fragments of one bar in length and associate them with a unique trigger sequence.

According to another aspect the invention provides a computer program product stored on a non-transitory computer-readable storage medium, comprising computer-executable instructions that cause a processor to perform the method of the first aspect of the invention.

### BRIEF DESCRIPTION OF THE DRAWINGS

There will now be described by way of example only, one embodiment of the present invention with reference to and as illustrated in the accompanying drawings of which:

FIG. 1 shows an illustrative block diagram of the main parts of a system in accordance with an aspect of the invention;

FIG. 2 is a schematic diagram that shows an embodiment of a system installed in a recording studio and being used by four players;

FIG. 3 is an illustrative process flow chart of the steps that are performed when a group of users a playing a song with the system of FIG. 1; and

FIG. 4 is an illustrative process flow chart of the steps that are performed by the processor when a trigger is received;

FIG. 5 is an illustration of the set of fragments that make up each part of a song;

FIG. 6 is a table showing how different triggers can be assigned to different difficulty levels;

FIG. 7 is an example of a simple trigger;

FIG. 8 is an example of a complex fragment that can be associated with a trigger; and

FIG. 9 shows the repeated playing of the fragments internally within the laptop between the start and end of a song with those that are output highlighted and bold and being the only ones that are audible.

### DETAILED DESCRIPTION OF THE PRESENT INVENTION

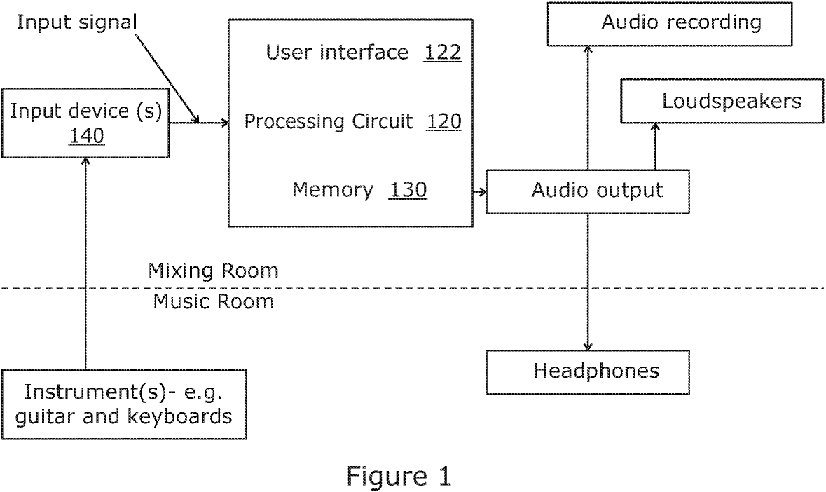

FIG. 1 shows a complete system 100 for enabling a piece of music to be played by a group of people, each being referred to in this description as a user of the system. The system will typically be located in a recording studio, where it may be prewired with all of the required inputs and output devices, and will come with a set of instruments that the players may use. A player could of course bring along an instrument of their own to use with the system. As will be explained parts of the piece of music may be played automatically as a backing track that can accompany the players.

As shown in FIG. 1 the system comprises a processing circuit 120, a storage device including an amount of electronic memory 130 for storage of data, a computer program stored in the memory 130 and a set of data associated with at least one song. The computer program comprises a set of instructions which when running on the processing circuitry cause the system to receive process input signals received from the instruments and to take appropriate actions to output a corresponding piece of music.

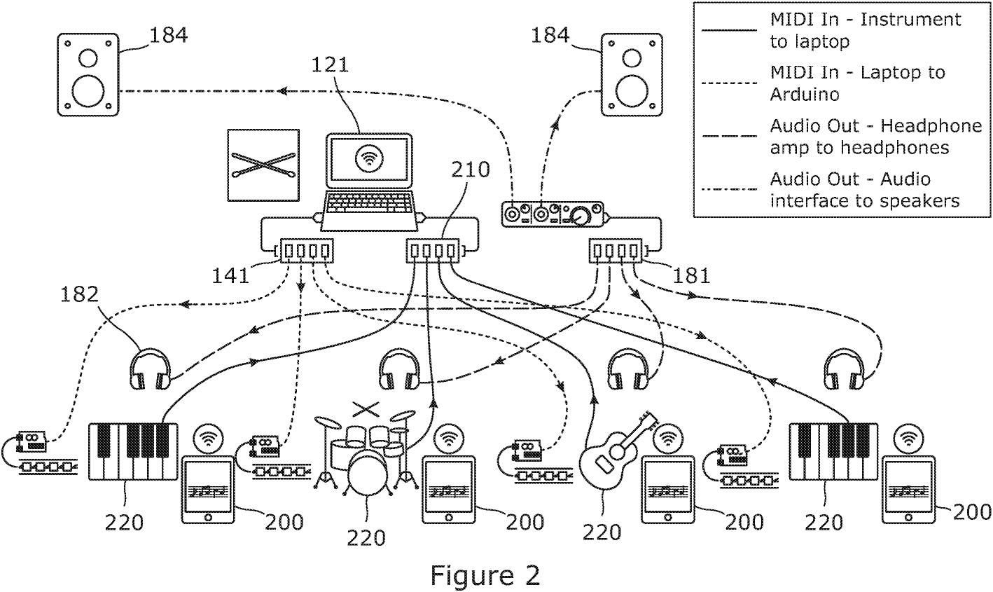

FIG. 2 shows a typical implementation of the system 100. As can be seen the system allows four people to play along together, each with their own instrument 220. In this example there are two people using keyboards, one a drum set and the other a guitar.

Each player generates one input signal in the form of a MIDI IN signal. All four signals are fed to a multiplexing device 210 that converts the four signals into a single multiplexed MIDI input signal that is fed into a laptop 121 that functions as the processing circuit 120. An output from the laptop 121 is connected to a demultiplexing device 181 which splits out a single audio signal from the laptop that encodes four song tracks into the respective tracks and feeds each audio signal to an audio device. In this case each of the four users has a set of headphones 182 that act as the audio device and replay the output signal that is associated with their playing. A second audio output signal that is not de-multiplexed feeds an amplifier (not shown) which in turn drives a set of loudspeakers 184. This second output signal encodes all four audio tracks to allow the entire song to be played out loud.

Each input stream of midi data encodes the notes played by a user and certain properties of those notes, in particular the time that each note is played. The input data stream is generated in real time so that each time a note is played it is encoded and input to the laptop as midi data. The input will accept multiple notes played simultaneously, in fact any sequence that can be played on the instrument will be encoded in the file, allowing the sequence to be audibly reproduced. Note that in this system the actual notes may not generally be audibly reproduced but instead function as triggers for alternative sequences of notes. In a modification a “midi thru’ function which allows these notes to be directly converted to audio signals and passed to the output so they can be heard or recorded, or to allow for an experienced musician to play the instrument ‘as is’ without assistance

The program running on the laptop 121 presents a graphical user interface 122 on the screen of the laptop that allows a technician to operate the system. If the screen is touch sensitive this may display buttons that can be pressed, or alternatively the technician may use a conventional keyboard or mouse or trackpad to interact.

The graphical user interface 122 also includes a control panel which enables a technician to interact with the systems for the purpose of choosing which song is to be played and the instruments and difficultly level and so on as will be explained below.

The memory 130 stores data defining many song parts. In this example each part of the piece of music corresponding to a played instrument is defined by a respective set of midi files. Each file corresponds to one fragment of one part of the piece of music which is a set of notes and their timing. By part of a piece of music we mean the notes that will be played by one of the players when performing the whole song. In the example of FIG. 2, there will be four sets of fragments: two guitar parts, one keyboard part and one drums part. By fragment we mean a small chunk of the piece of music, such as a single bar of music that is included in the piece of music.

In this example, a vocal track is also stored in the memory as an audio file, which may be fed to the output of the laptop as the song is played without the need for any triggers.

An important feature of each set of fragments is that if audibly output in the correct sequence at the correct time the whole of a part of the piece of music will output which may be reproduced audibly or recorded (or both) from those fragments.

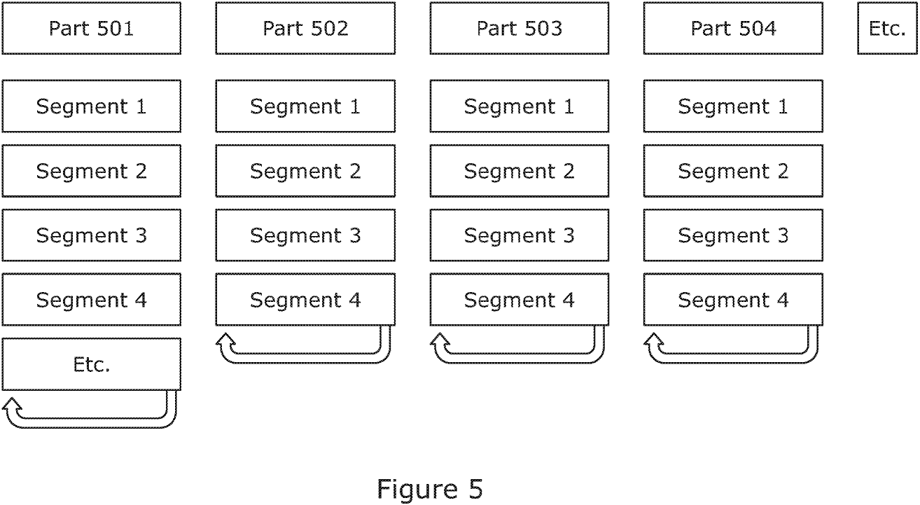

FIG. 5 shows a simple set of fragments for four parts 501-504 of an exemplary piece of music that may each by played by one of the four players. For each part there is a set of fragments that are to played, Fragments 1 to 3 etc. The precise timing of each segment within the bar will also be stored in the memory alongside or as part of the fragment file. There may be different fragments for each bar of the song, although some may repeat during the piece of music, for example if they form part of a chorus.

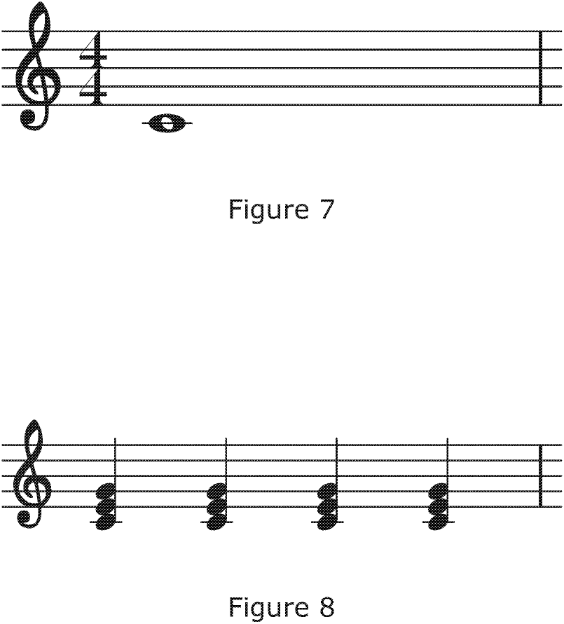

As well as storing the fragments the memory stores multiple sets of triggers. For each fragment there is at least one associated trigger. The triggers are single notes or combinations of notes that a user may play in order to trigger a corresponding fragment. Generally the triggers will be less complex than the associated fragments. FIG. 7 shows a simple input note forming a trigger, and FIG. 8 shows the more complex fragment that is associated with that trigger.

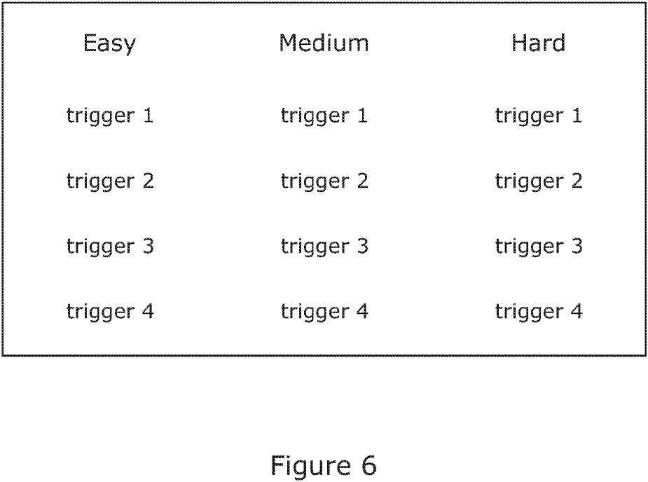

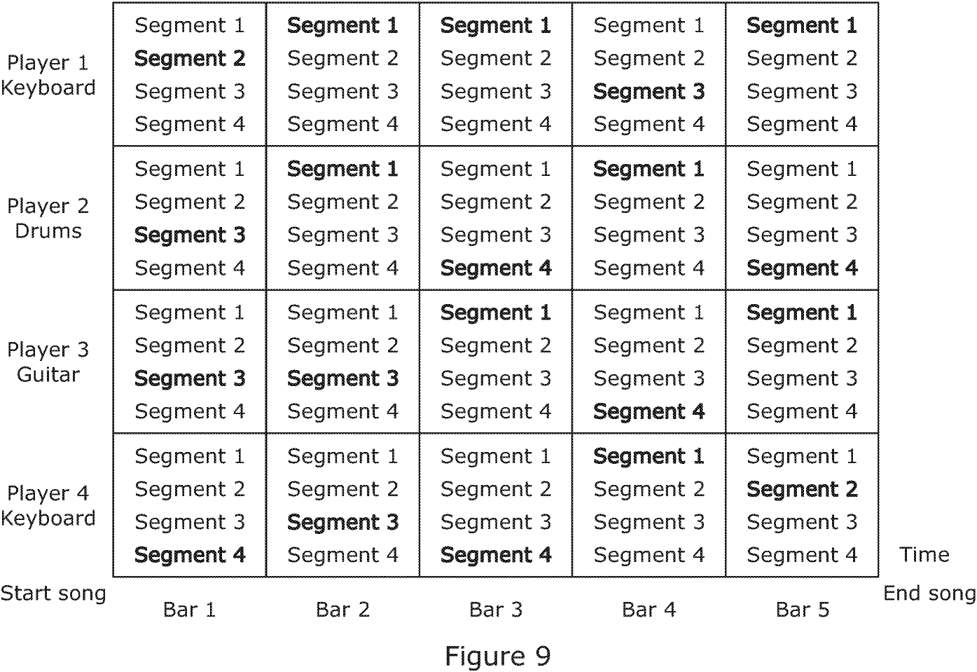

In the example of FIG. 2, each song part has associated with it three sets of triggers. The three sets correspond to three different difficulty levels- easy, medium and hard. The triggers for the easy set will generally be simpler than the triggers of the hard set, for instance single notes rather than complex combinations forming chords. This is shown in FIG. 6, with one trigger for each of the four fragments of FIG. 9.

One of the set of triggers is assigned to the player who wants to play a particular part of a piece of music. For example, the two keyboard players may be assigned the easy level for a part, and the drum and guitar players may be assigned the hard level for those parts. The keyboard players only need to play simple triggers to perform their part and the guitar and drums players must perform more complex triggers. Significantly, changing the difficulty level only changes the triggers, the audio output is made up of the triggered fragments and this will be the same regardless of difficulty level chosen.

The processing circuit is configured to analyse each input signal to identify within the signal each note of combination of notes that is being played. A combination is a set of notes played at the same time or almost at the same time, in this case within 20 milliseconds of the start of the first note.

The analysis matches the note or combination of notes with the set of triggers and if a match is found the associated fragment is output from the laptop to the output devices which in this example are the two loudspeakers and the headphones of the player playing that part of the song.

The laptop 121 is also connected to an additional output device 141 that enables cues to be presented to each player on a tablet device associated with that player. These cues tell the player what sequence of notes to play corresponding to the correct sequence of triggers. In the example this is embodied as computer tablet devices 200 that each display a graphical representation of the music on screen (e.g. score). In addition the example includes for each player a digital controller, such as an Arduino device, that powers and controls an illuminated strip attached to the instrument that guides the player on where to physically place their fingers. The skilled person will understand how to implement such a device and to control this by passing to the input of the device the musical score that is to be played.

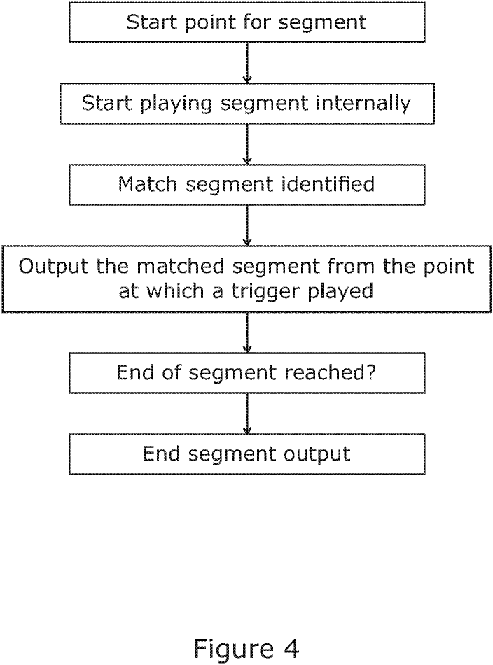

The system may be operated in two main operating modes. The first is a play mode which enables each player to select a piece of music, and to play along to generate the piece of music. The second is a programming mode that enables new pieces of music to be set up. The first mode is illustrated in the flow chart of FIG. 4 and the programming mode is illustrated in the flow chart of FIG. 5.

### The Play Mode

The play mode is used when a player or group of players in the studio wish to play along to a piece of music. When entering this mode the technician in charge of the laptop will enter the user’s names. They will also ask each player to choose the instrument they wish to play, perhaps even the type of instrument, and will ask the players what piece of music they want to play. They will also ask what level of difficulty each player wants to select. This information is then entered into the system, assigning the appropriate triggers and fragments to each player.

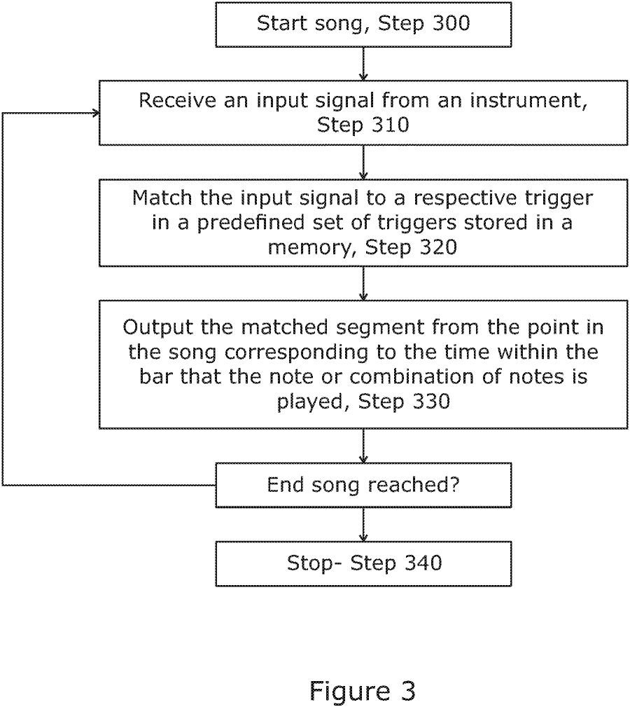

The players can then get into position within the studio with their instruments, don a pair of headphones and set up their tablet devices so they can see and follow the cues they are given. FIGS. 3 and 4 are flowcharts which set out the main steps that are carried out when a piece of music is performed.

The technician will start the piece of music, Step 300, which presents a start cue to the players. If there is a vocal track, this will start at the cue and continue to the end of the piece of music or whenever the vocals finish. This vocal track does not require any triggers to be played. Each player must then follow the cues, performing a sequence of triggers at the correct time to play their instrumental part of the piece of music. The laptop receives input signals from the players, Step 310. From the start of the piece of music, the laptop will play each of the fragments internally on a loop, synchronised to a predefined time within each bar of the piece of music or selected bars. For instance, a fragment of length of one bar may be synchronised to start on the first beat of every bar and will loop around to repeat on each first beat. The exact start time will be selected according to when within the bar structure of the piece of music the fragment should start in the played or recorded piece of music if triggered at the right time.

The played files will remain looping on the laptop but not output to the audio devices for the duration of the piece of music. During this time the laptop will analyse the input signal to see if a match can be made to a trigger, indicating that the trigger has been played, step 320. If the laptop matches an input note or combination of notes to a trigger for a fragment, the fragment will be fed in Step 330 to the output starting from the point within the fragment corresponding to the time the note was played. The laptop or the output convert the fragment from midi data to audio data at this point. This will pass the fragment to the output at the start of the fragment if the trigger is played at the right time, or part way through if the timing is off. Once the end of a fragment is reached it will go back to only playing internally.

The system will continue receiving input signals for the players until the end of the run time of the piece of music is reached at Step 340. It will then stop in this example. If each player played the correct sequence of triggers, the piece of music will have been audibly reproduced, or recorded, or both, perfectly.

FIG. 4 gives more detail of the matching and output process for a single fragment.

The final output is shown in FIG. 9, with the audio signal form of the fragments highlighted in bold being fed to the loudspeakers and headphones whilst the others are not output and do not need to be converted to audio signals. Note that fragments 1 to 4 for the first bar may differ from fragments 1 to 4 of the later bars, and that the start time for each fragment within a bar (when the user should play the trigger) may vary.

This system allows a player to perform a complex piece of music with only a relatively simple set of triggers.

### Programming Mode

The programming mode is used to create and store the fragments and triggers that are needed for the play mode.

If the data already exists in the form of triggers and fragments, then programming the piece of music into the system is as simple as downloading the files encoding those triggers and fragments into the memory that is accessible to the laptop.

If the fragments do not exist, the process of creating them can be performed by downloading an entire part of a piece of music, from start to end of the musical part, as a midi file and then splitting or chopping it up into shorter fragments. The point at which each fragment starts within a bar is then also stored alongside or as part of each fragment.

To generate the triggers, a simplified performance of the track may be performed and then chopped up to form the set of triggers, or these may be manually generated using a computer interface.

1. A method for performing a piece of music comprising the steps of:
receiving an input signal from a musical instrument, the inputs signal encoding the notes played on the instrument,
matching a note or combination of notes in the input signal to a respective trigger in a predefined set of triggers stored in a memory, each trigger being associated with a respective fragment of music that makes up a part of the piece of music, each fragment having a predefined length and starting from a predefined position relative to the start of a bar, and at least one of the fragments being more complex than the associated trigger,
characterised in that when a note or combination of notes that matches a trigger is played by the user the method outputs at least part of the matched fragment that starts at the time that the note or combination of notes is played.

2. A method according to claim 1 including setting a preset threshold time for determining if the user has played a combination of notes simultaneously and to take each note as part of the trigger.

3. A method according to claim 1 in which the step of outputting a fragment from the point where it is triggered comprises passing the fragment to an audio playback device from that point.

4. A method according to claim 1 in which each of the fragments corresponds to a portion of the piece of music being played that has a duration equal to one bar or a duration that is less than a bar.

5. A method according to claim 1 in which a fragment is associated with only one bar or selected bars in the piece of music so that it will only be output if the correct trigger is played at that time or within the duration of the fragment.

6. A method according to claim 1 in which all fragments start on the first beat of a bar and at least one fragment includes an initial period of padding with no notes if the notes are not to output until later in the bar.

7. A method according to claim 1 comprising playing each fragment on mute on a loop synchronised to the predefined start time for each fragment and the step of outputting a part of a fragment associated with a matched trigger comprises turning off the mute from that point in time within the fragment when the note or combination notes associated with the trigger is played so the rest of the fragment can be heard until the end of the fragment whereupon it continues to play on mute.

8. A method according to claim 1 comprising providing multiple sets of fragments, each set corresponding to one part of the piece of music.

9. A method according to claim 1 comprising processing more than one trigger sequence associated with each set of fragments.

10. A method according to claim 9 further comprising permitting the user to define the specific instrument from a type of instruments to be selected and thereby choose which set of fragments they will trigger.

11. A method according to claim 1 further comprising providing two or more sets of trigger signals, each associated with a different level of difficulty, and assigning a difficulty level to each user, thereafter only matching the input note or combinations of notes to the chosen set of triggers.

12. A method according to claim 1 further comprising providing additional feedback to a user to indicate their performance compared to an ideal performance.

13. A method according to claim 1 further comprising providing cues to the user to aid them in playing the correct note or correct sequence of notes at the correct time.

14. A method according to claim 1 comprising receiving from a user a selection of a piece of music, and selecting the appropriate set of triggers and fragments that enable that piece of music to be played.

15. A system for assisting a user in playing along to a piece of music, the system comprising:
A a processing circuit having access to information stored in at least one storage device,
an input device for receiving from a user an electronic signal encoding a note or combination of notes played by the user, a set of stored trigger signals,
a set of stored fragments of music, each fragment having a predefined length and starting from a predefined position relative to the start of a bar, and
an output device,
in which the processing circuit is configured to match the input signal to a respective trigger, each trigger being associated with one of the stored fragments,
and in which the processing circuit is further configured to cause the output device to play audibly or record the matched fragment from the point in the piece of music corresponding to the time within the bar that the note or combination of notes of the input signal is played.

16. A system according claim 15, in which the processing circuit is further configured to cause the output device to:
play each fragment on mute on a loop synchronised to the predefined start time for each fragment; and
turn off the mute from that point in time within the fragment when the note or combination notes associated with the trigger is played so the rest of the fragment can be heard until the end of the fragment whereupon it continues to play on mute.

17. A system according claim 15, in which the processing circuit is further configured to provide two or more sets of trigger signals, each associated with a different level of difficulty, and assign a difficulty level to each user, thereafter only matching the input note or combinations of notes to the chosen set of triggers.
